(19) United States
(12) Patent Application Publication
(10) Pub. No.: US 2021/0201336 A1
(43) Pub. Date: Jul. 1, 2021

(54) APPARATUS AND METHOD FOR MANAGING BRANDED DIGITAL ITEMS

(71) Applicants: Jeffrey R. Mallett, Sunnyvale, CA (US); Christian Ferri, Palo Alto, CA (US)

(72) Inventors: Jeffrey R. Mallett, Sunnyvale, CA (US); Christian Ferri, Palo Alto, CA (US)

(21) Appl. No.: 17/199,336

(22) Filed: Mar. 11, 2021

Related U.S. Application Data
(63) Continuation of application No. 17/187,661, filed on Feb. 26, 2021.
(60) Provisional application No. 62/983,643, filed on Feb. 29, 2020.
(60) Provisional application No. 60/080,771, filed on Apr. 6, 1998.

(51) Int. Cl. G06Q 30/02; G06F 3/0484; G06F 3/0482

(52) U.S. Cl. CPC G06Q 30/0201; G06F 3/0482; G06F 3/04842

(57) ABSTRACT

A system and method for managing branded digital items is provided. One embodiment generates a branded digital item in response to an agreement between a brand client and a content provider to use a branded product in a digital environment of the content provider, wherein the branded digital item is a recognizable graphical object; generates a branded digital item blockchain that includes a non-fungible token associated with the branded digital item; receives information corresponding to a purchase of the branded digital item by a user; and updates the non-fungible token to memorialize purchase of the branded digital item by the authorized user, wherein the updated non-fungible token is returned to a ledger of the branded digital item blockchain.

### PRIORITY CLAIM

This application claims priority to copending U.S. Non-Provisional application Ser. No. 17/187,661, filed on Feb. 26, 2021, entitled Apparatus and Method for Managing Branded Digital Items; U.S. Provisional Application, Ser. No. 62/983,643, filed on Feb. 29, 2020, entitled A Method To Create And Manage Digital Assets; and copending U.S. Provisional Application, Ser. No. 60/080,771, filed on Sep. 20, 2020, entitled System For Branded Digital Items In Games And XR Environments Including Rewards, which are hereby incorporated by reference in their entirety for all purposes.

### BACKGROUND OF THE INVENTION

People are spending more and more time in digital environments. Such digital environments are provided by content providers. Example digital environments include social networks, video games, virtual realities (VR) and digital platforms.

Typically, the user interacts with the digital environment with an intended purpose. The digital environment receives input from the user and provides output on a display of an electronic device being used by the user, such as a smart phone, a personal computer, a laptop computer, or specialized game device. Typically, a user may interact with a digital game environment to play and possibly win a game.

While playing the game, the user may view gameplay on their display. Often, an avatar corresponding to the user is presented on the display so that the user perceives that they are a participant “in” the game. An avatar is an icon or graphical figure that represents the user. Other avatars may be visible to the user while playing the game. Some avatars may represent game artifacts, such as physical objects or game characters that the user interacts with.

Often, such video games allow multiple users to concurrently play the video game in a manner that lets the users interact with each other. While playing the game, the user may view gameplay showing avatars of the other users on their display.

As another example, digital social media environments may facilitate interactions between the user and other people and/or organizations. For example, the user may chat with other people (a form of real time, or near real time, textual messaging). When chatting with other people, an avatar representing the user and the other people may be presented on the display. Alternatively, or additionally, the user may post (publish) a message on the digital social media environment. The message may include text, still images, and/or video images. An avatar or the like may be presented on the message so that when other people using the digital social media environment view the message, they also view the user's avatar.

As yet another example, the user may “enter into” a digital VR environment where the user views a virtual reality world using a VR headset. In some digital VR environments, other people who are in the VR environment are visible to the user as avatars. The user may interact with the other avatars to simulate personal interactions between the user and the other people represented by their avatar.

Most online users engaging in these digital environments do not have the ability to identify themselves in the digital environment in the same way they are able to identify themselves in the physical, real world. For example, online users cannot identify with branded products they use in their daily physical lives, such as branded apparel, branded accessories, branded consumables, branded vehicles, or the like. Online users, represented as avatars in a digital environment, are therefore limited in their form of personal expression because the digital environments currently do not provide the same dynamics of “commerce” that the physical world does. That is, the user who has purchased a particular vehicle, such as a particular branded motorcycle, cannot play a motorcycle themed digital game environment where their avatar is “riding” their particular motorcycle. Rather, the user must “ride” a digital motorcycle avatar selected from one of a plurality of digital motorcycle avatars provided by the game publisher.

Because the user is not able to customize their digital environment avatars, nor customize other graphically represented digital objects that the user is interacting with, their enjoyment of a particular digital environment may be diminished. Accordingly, in the arts of digital environments, there is a need in the arts for improved methods, apparatus, and systems for enabling a user to customize their avatar or other personal digital objects in accordance with their personal preferences.

### SUMMARY OF THE INVENTION

Embodiments of the branded digital item system provide a system and method for managing a branded digital item. A system and method for managing branded digital items is provided. One non-limiting example embodiment generates a branded digital item in response to an agreement between a brand client and a content provider to use a branded product in a digital environment of the content provider, wherein the branded digital item is a recognizable graphical object; generates a branded digital item blockchain that includes a non-fungible token associated with the branded digital item; receives information corresponding to a purchase of the branded digital item by a user; and updates the non-fungible token to memorialize purchase of the branded digital item by the authorized user, wherein the updated non-fungible token is returned to a ledger of the branded digital item blockchain.

### BRIEF DESCRIPTION OF THE DRAWINGS

The components in the drawings are not necessarily to scale relative to each other. Like reference numerals designate corresponding parts throughout the several views.

FIG. 1 is a block diagram of branded digital item system.

FIG. 2 is a flowchart illustrating the operation of the branded digital item system of FIG. 1.

FIG. 3 is a conceptual diagram of a user's avatar during gameplay.

FIG. 4 is a conceptual presentation of branded digital items that are available for purchase by the user.

FIG. 5 is a conceptual presentation of a group of bundled branded digital items that are available for purchase by the user.

FIG. 6 is a conceptual presentation of a digital wallet that shows purchased digital items that are available for use by the user.

FIG. 7 is a conceptual presentation of the user “wearing” selected ones of the digital items that the user has selected from their digital wallet.

FIG. 8 conceptually illustrates a graphical user interface that permits a user to select a purchased branded digital item in a selected digital environment.

### DETAILED DESCRIPTION

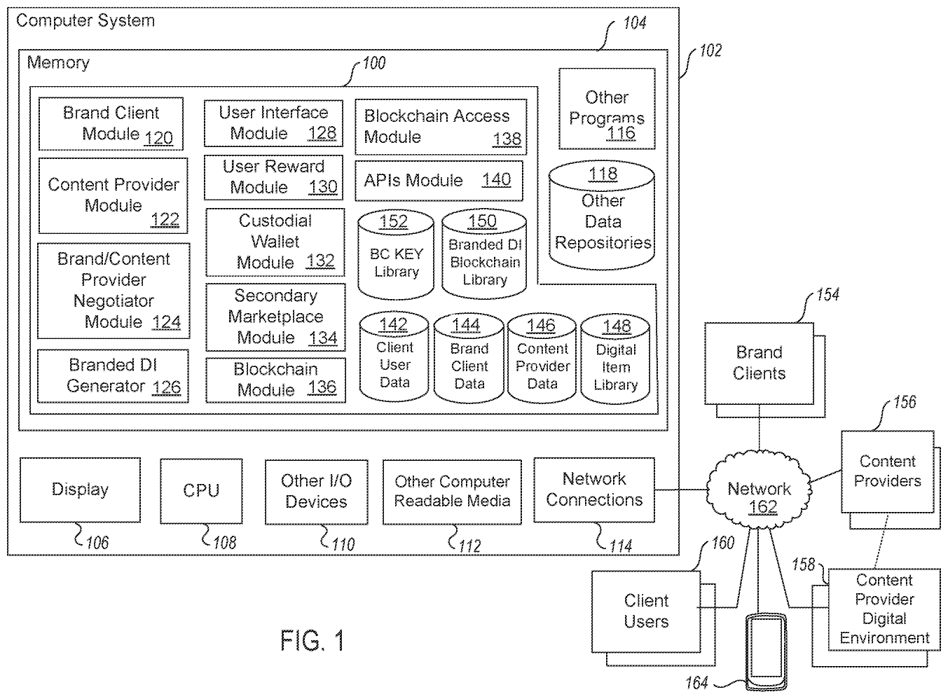

FIG. 1 is a block diagram of branded digital item system 100. Embodiments of the branded digital item system 100 are implemented on a special purpose computing system 102. The branded digital item system 100 provides a meeting place for brand clients to meet with content providers to negotiate and agree upon generation and use of a branded digital item by a purchasing user in a digital environment.

A brand client is defined as an organization or entity that produces, markets and/or sells a branded item. The branded item may be a physical object, such as, but not limited to, consumables (i.e., food, beverages, etc.), vehicles (i.e., a car, a boat, a motorcycle, an airplane, a helicopter, etc.), apparel (i.e., a shirt, a dress, a pair of pants, a pair of shoes, an undergarment, a coat, a hat, etc.), accessories (i.e., a handbag, a suitcase, jewelry, etc.), or any other physical object that is identifiable by a brand. A branded item may also be a non-physical object, such as, but not limited to, music, icons, trademarks, or the like. In the context of this disclosure, a branded item is any item that is readily identifiable by some characteristic, such as a logo, particular colors, a brand name, a particular shape or design, etc. Such branded items are well known in the public realm so as to be readily identifiable. Further, brand items are typically very desirable by consumers, and often command a premium price in the marketplace.

A content provider is an organization or entity that provides a digital environment for use by a user. Some content providers provide a digital game environment for gameplay by a user or a plurality of users. Typically the game is played by one or more users in an interactive manner on a real time basis.

Other interactive content providers provide a digital social media environment for use by a plurality of users. Often, such users have a common interest and/or personally know each other. The digital social media environment facilitates personal interactions between such users.

Some content providers provide a digital virtual reality (VR) environment to one or more users. The digital VR environment enables the one or more users to “enter into” a virtual reality for some purpose, such as to interact with other users, to play a game, to attend a virtual concert, or to consume some other VR experience.

Once a particular brand client and a particular content provider have negotiated an agreement, a branded digital item is created by embodiments of the branded digital item system 100 or another entity. A digital item is graphical object that is presented in a particular digital environment. Based upon the negotiated agreement, the digital object is branded to generate a branded digital item. A branded digital item is a graphical object that is readily recognizable to a user of the digital environment based on the branding information that is shown on the digital item.

For example, an avatar associated with the user may “wear” a piece of apparel in the digital environment. When the user, or other users, view the avatar that is being presented on a display, the user and these other users readily recognize the branded piece of apparel. As another, example, the digital item may represent a physical object, such as a weapon for use in a video game associated with war themed activities. Here, the branded weapon would be readily recognizable to both the user and other users during gameplay, and thus impart a sense of importance or value to those viewing game-playing users. As another example, a digital item may be a motorcycle for use in a motorcycle racing video game, or the like. Here, a branded motorcycle would be readily recognizable as representing the brand client's motorcycle, and thus impart a sense of importance or value to those viewing game-playing users.

Within the context of this disclosure, a branded digital item may be referred to as a skin in the arts. A skin is a two dimensional (2D) model or three dimensional (3D) model of a graphical object of interest. When presented on a display, the 2D and/or 3D model data of the skin is used to render and present a visual image of the object of interest.

Skins may be overlaid on to or over other graphical objects. For example, but not limited to, a skin representing a shirt may be overlain on top of an avatar of a user such that the user's avatar appears to be wearing that particular shirt. If the shirt is a branded shirt (a branded digital item), then the branded digital item shirt is readily identifiable by the viewing users because the branded shirt is associated with the well-known brand client that manufactures, markets or sells the corresponding branded physical shirt.

As another non-limiting example, the skin may be a motorcycle that the user rides during play of a motorcycle racing game. During gameplay, the user's avatar is presented as “riding” the motorcycle. If the skin is a branded motorcycle, the user and other game players will view presentation of the user “riding” the branded motorcycle, which is readily recognizable to all game players.

Because of the fame of a branded digital item, users of the digital environment perceive and associate a higher value to a branded digital item as compared to a corresponding unbranded digital item. The higher value may be perceived in terms of prestige or the like. Accordingly, a monetary value may be associated with a branded digital item (as compared to a corresponding unbranded digital item). Further, the greater fame of the brand client, a higher valuation may be associated with that branded item. That is, a branded digital item will have a higher market value that a user is willing to pay to obtain a branded digital item (branded digital skin) for use in a particular digital environment.

Further, scarcity of a particular branded digital item may affect valuation of the branded digital item. For example, if the users of a digital environment know that only ten instances of a particular branded digital item are available for use in that digital environment, then the branded digital item may command a price premium because of this scarcity. However, the users of the digital environment, and especially the purchasing user, must have a sense of security that there will be no additional like-branded digital items that will be later available for that digital environment. That is, if the user purchases one of ten branded digital items, the purchasing user must be assured that no more than ten of the branded digital items will ever be available for use in the digital environment. Further, the purchasing user will want to be able to prove and document that they are the true owner of the purchased branded digital item.

Embodiments of the branded digital item system 100 provide a platform by which a brand client and a content provider can negotiate an arrangement to generate a branded digital item for use on the content provider's digital environment. Embodiments of the branded digital item system 100 facilitate the process of a brand client and a content provider of discovering each other, and then recognizing the opportunity to create a branded digital item. Further, embodiments of the branded digital item system 100 facilitate the negotiation process between a brand client and a content provider.

Once an agreement is reached between the brand client and the content provider, a branded digital item is generated by embodiments of the branded digital item system 100 or another entity, such as the content provider who is familiar with their digital environment. The branded digital item is 2D and/or 3D model data that is used to generate an image of the branded digital item when the user is using that particular digital environment. Alternatively, the branded digital item may be generated by another remote system and then be optionally communicated back to the branded digital item system 100.

Then, in some embodiments, the branded digital item may be incorporated into a digital blockchain by embodiments of the branded digital item system 100. In a preferred embodiment, a non-fungible token is generated after an agreement is reached between the brand client and the content provider. The non-fungible token memorializes the creation of the branded digital item. Preferably, the agreement between the brand client and the content provider has negotiated some predefined number of branded digital items that will be available for use in the digital environment.

Based on this agreed-to predefined number of available branded digital items, a corresponding number of non-fungible tokens are generated, wherein each token is associated with one of the predefined number of available branded digital items. Alternatively, a non-fungible token may be generated in response to a user, wherein the number of generated non-fungible tokens is limited in accordance with the agreement. Here, digital scarcity of the branded digital items is facilitated by uniquely associating one non-fungible token with one instance of the agreed-to predefined number of branded digital items. A unique edition number may be assigned to each one of the non-fungible tokens to uniquely identify that particular non-fungible token as being a member of the agreed-to number of branded digital items.

The non-fungible token includes various information of interest that are associated with a particular instance of a branded digital item. For example, but not limited to, the information may identify the brand product of the brand client, identify the brand client, identify the digital environment(s) that the branded digital item may be used in, identify the content provider, identify the creation date of the branded digital item, and/or identify the edition number of the branded digital item.

A branded digital item blockchain is then generated with a ledger containing each of the instances of the non-fungible tokens. A cryptographically secured hash of the branded digital item blockchain is generated and added into the ledger of the branded digital item blockchain. Accordingly, the contents of the ledger are secured.

At some later time, a user of the digital environment will purchase the branded digital item, or otherwise obtain use rights to use a branded digital item. A selected one of the non-fungible tokens is then associated with that purchasing user. Then, the information in the selected non-fungible token is modified. The information of that particular non-fungible token is accessed from the ledger and the information in the selected non-fungible token is modified accordingly. For example, but not limited to, the identity of the authorized user, when the branded digital item was purchased, and/or the purchase price may then be included in the selected non-fungible token. After the information in the selected non-fungible token is updated, the updated token information is returned to the ledger. A new hash may then be computed to secure the ledger of the branded digital item blockchain.

In a non-limiting example embodiment, the 2D and/or 3D model data that is generated for the branded digital item may be unique to the digital environment of the content provider. Typically, the branded digital item is generated by the content provider since the content provider understands the formatting and implementation requirements of the 2D and/or 3D model data that is to be used in their digital environment. The 2D and/or 3D model data may then be held by and/or maintained by the content provider.

In some digital environments, the 2D and/or 3D model data may be compiled into the digital environment with controls that limit use of the branded digital item only to authorized users. During use of the digital environment by the user, the non-fungible token information associated with that authorized user can be accessed to confirm authorization to use the branded digital item by that particular authorized user.

In other digital environments, the 2D and/or 3D model data for the branded digital item may be linked to the digital environment, and then called into the digital environment in response to a user request to use their branded digital item in the digital environment. In such embodiments, the non-fungible token may optionally include one or more links that are associated with and used to access the 2D and/or 3D model data. This embodiment may be particularly useful in situations where the 2D and/or 3D model data may be used in different digital environments maintained by the content provider, or when the 2D and/or 3D model data may be used in multiple digital environments maintained by different content providers.

In an alternative embodiment, a digital blockchain includes a non-fungible token that securely stores the 2D and/or 3D model data of the branded digital item possibly using an encrypted format. Alternatively, or additionally, link information to the 2D and/or 3D model data may be included in the branded digital item non-fungible token. The branded digital item non-fungible token may also include other supplemental information associated with the branded digital item. Such supplemental information may identify the brand client, the interactive content provider, the digital environment, the date of creation, when the branded digital item was purchased, and/or identifying information that identifies the purchasing user. One skilled in the art appreciates that when the branded digital item non-fungible token is generated by a blockchain program, the data incorporated into the non-fungible token is immutable. That is, the data cannot be changed without later detection of any unauthorized changes. Further, if some later event that is to be memorialized by data within the digital blockchain, an updated branded digital item non-fungible token is subsequently generated with the updated information.

When the branded digital item non-fungible token is initially generated, one skilled in the art appreciates that no user has yet purchased that associated branded digital item. When a user purchases the branded digital item, the transaction details (price, date, etc.) and the user identity are added into the information of the non-fungible token of the branded digital item blockchain in a secure manner. When the user is active in the associated digital environment, proof of ownership of the branded digital item, as indicated in the information of the non-fungible token, is provided to the digital environment (once user authentication is verified). That is, only the purchasing user is allowed access to the branded digital item for use in the associated digital environment.

Further, in a market place environment supported by embodiments of the branded digital item system 100, an owning user (authorized user) may sell their branded digital item to another user. Here, ownership transfer information memorializing sale and ownership transfer of the branded digital item is added into the information of the associated non-fungible token in the branded digital item blockchain, depending upon the embodiment. The updated non-fungible token information in the updated branded digital item blockchain includes the identity of the new purchasing user and other relevant supplemental information. Then, only the new purchasing user may use that branded digital item in the digital environment.

Optionally, a reward or incentivization system may be incorporated into the information of the non-fungible token or the branded digital item blockchain by embodiments of the branded digital item system 100. When a rewards or incentive program is available, an owner user performs a certain task to qualify for the reward or incentive. After completion of the reward or incentive task, the user may be presented a reward or incentive. The reward or incentive may be monetary based, such as a redemption coupon, a discount coupon or the like. Alternatively, or additionally, the reward or incentive may be based upon some aspect of the digital environment, such as virtual point, virtual jewels, virtual objects or the like.

The disclosed systems and methods for creating and managing branded digital items using embodiments of a branded digital item system 100 will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of examples for systems and methods for a branded digital item system 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Summarizing, embodiments of the branded digital item system 100 ensure authenticity of a branded digital item. Users know that the asset (branded digital item) has been issued by the brand client and sold to them, proving authenticity of the item. Embodiments of the branded digital item system 100 ensure digital scarcity of the branded digital item. Users will be able to own one asset of a pre-defined batch of the same branded digital item, allowing the branded digital item to maintain its value in the digital realm. Embodiments of the branded digital item system 100 ensure true ownership of the branded digital item. When buying the branded digital item, the user will truly own the branded digital item in their wallet, and will be able to resell it or monetize it in other ways such as by renting it out to other users, just like as done with branded physical objects in real life. Embodiments of the branded digital item system 100 ensure programmability, The branded digital item may be pre-programmed with incentives and rewards that the user can redeem after a series of steps. Rewards are, for example, discounts for the purchase of the physical twin, a discount for purchase of another digital asset from the same brand, or status upgrades. Embodiments of the branded digital item system 100 may provide interoperability among a plurality of digital environments. That is, once a branded digital item is purchased, a user can port and use the same branded digital item across other digital environments, such as, but not limited to, across games, VR metaverses, augmented reality (AR) environments, and/or social platforms.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire based connector, whether directly or indirectly through a communication network 108. “Controllably coupled” means that an electronic device controls operation of another electronic device.

Returning to FIG. 1, an example embodiment of a branded digital item system 100 is represented as a block diagram of an example computing system 102 that may be used to practice embodiments of the branded digital item system 100 described herein. Note that one or more general purpose virtual or physical computing systems and/or a special purpose computing system, when suitably instructed, may be used to implement an embodiment of the branded digital item system 100. Further, the branded digital item system 100 may be implemented in software, hardware, firmware, or in some combination to achieve the capabilities described herein. However, just because it is possible to implement the branded digital item system 100 on a general purpose computing system does not mean that the techniques themselves or the operations required to implement the techniques are conventional or are well known.

The computing system 102 may comprise one or more server and/or client computing systems, and may span distributed locations. In addition, each block shown in FIG. 1 may represent one or more such blocks as appropriate to a specific embodiment, or may be combined with other blocks. Moreover, the various blocks of the branded digital item system 100 may physically reside on one or more machines, which use standard (e.g., TCP/IP) or proprietary interprocess communication mechanisms to communicate with each other.

In the embodiment of the branded digital item system 100 shown in FIG. 1, computer system 102 comprises a computer memory (“memory”) 104, a display 106, one or more Central Processing Units (“CPU”) 108, one or more Input/Output (I/O) devices 110 (e.g., keyboard, mouse, CRT or LCD display, etc.), other computer-readable media 112, and one or more network connections 114. The branded digital item system 100 is shown residing in memory 104. In other embodiments, some portion of the contents, some of, or all of the components of the branded digital item system 100 may be stored on and/or transmitted over the other computer-readable media 112. The components of the branded digital item system 100 preferably execute on one or more CPUs 108, and manage the generation and use of branded digital items and the associated branded digital item blockchains, as described herein. Other code or programs 116, and potentially other data repositories such as data repository 118, may also optionally reside in the memory 104, and preferably execute on one or more CPUs 108 to perform other tasks not described herein. Of note, one or more of the components in FIG. 1 may not be present in any specific implementation. For example, but not limited to, some embodiments embedded in other software may not provide means for input or display by a person managing the branded digital item system 100.

In an example embodiment, components/modules of the branded digital item system 100 are implemented using standard programming techniques. For example, the branded digital item system 100 may be implemented as a “native” executable running on the CPU 108, along with one or more static or dynamic libraries. In other embodiments, the branded digital item system 100 may be implemented as instructions processed by a virtual machine. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described herein may also use well-known or proprietary, synchronous or asynchronous, client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and in different components/modules, yet still achieve the described functions.

In addition, programming interfaces to the data stored as part of the branded digital item system 100 (e.g., in the data repositories 118 or other memory data repositories) can be available by standard mechanisms such as through C, C++, C#, and Java APIs; libraries for accessing files, databases, or other data repositories; through scripting languages such as XML; or through Web servers, FTP servers, or other types of servers providing access to stored data. The branded digital item system 100 may be implemented using one or more database systems, file systems, or any other technique for storing such information, or any combination of the above, including implementations using distributed computing techniques.

Also the example branded digital item system 100 may be implemented in a distributed environment comprising multiple, even heterogeneous, computer systems and networks. Different configurations and locations of programs and data are contemplated for use with techniques of described herein. In addition, a server and/or client may be physical or virtual computing systems and may reside on the same physical system. Also, one or more of the modules of the branded digital item system 100 may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of the branded digital item system 100.

Furthermore, in some embodiments, some or all of the components of the branded digital item system 100 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

Embodiments of the branded digital item system 100 comprise a brand client module 120, a content provider module 122, a brand/content provider negotiator module 124, a branded digital item (DI) generator 126, a user interface module 128, a user reward module 130, a custodial wallet module 132, a secondary market module 134, a blockchain module 136, a blockchain access module 138 and an APIs module 140. These modules perform various functionality used during operation of an example embodiment of the branded digital item system 100. In alternative embodiments, some of these modules may be omitted, additional modules may be added, and/or some modules may be combined with other modules. In a distributed architecture module, one or more of these modules may be remotely located in another memory medium and/or executed by a remotely located CPU 108.

Embodiments of the branded digital item system 100 have portions of the memory 104 for storing client user data 142, brand client data 144, content provider data 146, a digital item library 148, a branded digital item (DI) blockchain library 150, and a blockchain (BC) key library 152. In alternative embodiments, the data and/or libraries may be stored with other data and/or libraries, and/or may be stored locally or remotely.

The network connection 114 communicatively couples the branded digital item system 100 to a plurality of brand clients 154, a plurality of content providers 156, a plurality of content provider digital environments 158, a plurality of client users 160, and optionally one or more user electronic devices (such as a smart phone 164) via a network 162. A client user 160 is an electronic device (with or coupled to a display) that the user is using, such as to play or use a digital environment of interest. The network 162 is illustrated as a generic communication system. Conceptually, the network 162 may be the Internet.

In one embodiment, the network 162 further comprises a cellular telephone system, such as a radio frequency (RF) wireless system. Accordingly, the network connections 114 may include a suitable wireless transceiver. Alternatively, or additionally, the network 162 may be a telephony system, a Wi-fi system, Bluetooth, a near-field communication system, a microwave communication system, a fiber optics system, an intranet system, a local access network (LAN) system, an Ethernet system, a cable system, a radio frequency system, a cellular system, an infrared system, a satellite system, or a hybrid system comprised of multiple types of communication media. Alternatively, or additionally, embodiments of the branded digital item system 100 may be implemented to communicate using other types of communication technologies, such as but not limited to, digital subscriber loop (DSL), X.25, Internet Protocol (IP), Ethernet, Integrated Services Digital Network (ISDN) and asynchronous transfer mode (ATM), and 4G/5G wireless networks. Also, embodiments of the branded digital item system 100 may be configured to communicate over combination systems having a plurality of segments which employ different formats for each segment that employ different technologies on each segment.

In practice, a brand client 154 may begin an interaction with the branded digital item system 100 by communicating a request to the branded digital item system 100. In response to receiving the request, the brand client module 120 is executed by a CPU 108. The brand client module 120 manages a variety of functions that a brand client 154 may want to perform.

For example, but not limited to, the brand client 154 may upload various data pertaining to their organization, their brands, and/or their branded products. This information may be stored in the brand client data 144. The brand client 154 may upload information identifying their organization, information pertaining to their brands (such as a trademark, logo, or the like), and/or information describing their branded products. Any suitable information of interest may be uploaded and saved into the brand client data 144.

The brand client 154 may also upload various conditions under which they would be willing to negotiate. The brand client 154 might upload expected pricing information for use of their brand. The brand client 154 might upload limitations that define use limits to their brand and/or branded products. For example, but not limited to, the brand client 154 may be socially conscious, and indicate that they will not engage with a content provider 156 that provides a war themed digital game and/or an adult oriented digital environment. As another example, the brand client 154 may indicate preferences pertaining to characteristics of the digital environments that they believe may be particularly well suited for their branded products. For example, a brand client 154 that produces motorcycles may indicate an interest in digital environments that feature motorcycles and/or motorcycle racing. The brand client module 120 would ensure that content providers 156 having digital environments that are restricted do not enter into negotiations with that brand client 154.

When the brand client module 120 is executing, a graphical user interface (GUI) is communicated to the brand client 154, via the network connection 114. The GUI may present the information on a display that has been provided by the brand client 154. The brand client 154 may then review and/or modify their information.

Alternatively, or additionally, the presented GUI may present information pertaining to subscribing content providers 156 who may be interested in using the branded digital item system 100 to provide branded digital items to their users. The brand client 154 can then identify one or more content providers 156 of interest. The brand/content provider negotiator module 124 may then reach out to those particular content providers 156 to initiate a transaction to use the brand of the brand client 154 in a branded digital item.

In practice, a content provider 156 may begin an interaction with the branded digital item system 100 by communicating a request to the branded digital item system 100. In response to receiving the request, the content provider module 122 is executed by the CPU 108. The content provider module 122 manages a variety of functions that a content provider 156 may want to perform.

For example, but not limited to, the content provider 156 may upload various data pertaining to their organization, their digital environment, and/or digital items used in their digital environment that may be suitable for branding. This information may be stored in the content provider data 146. The content provider 156 may upload information identifying their organization, information pertaining to their brands (such as a trademark, logo, or the like), and/or information describing their branded products. Any suitable information of interest may be uploaded and saved into the content provider data 146.

The content provider 156 may also upload various conditions under which they would be willing to negotiate. For example, but not limited to, the content provider 156 may indicated expected pricing for access to their digital environment. For example, but not limited to, the brand client 154 might upload limitations that define use limits to their brand and/or branded products. Alternatively, or additionally, the content provider 156 may be socially conscious, and indicate that they will not engage with a brand client 154 that provides adult themed products. As another example, the content provider 156 may indicate preferences pertaining to characteristics of their digital environment that they believe may be particularly well suited for a particular type of branded digital item.

When the content provider module 122 is executing, a GUI is communicated to the content provider 156, via the network connection 114. The GUI may present the information provided by the content provider 156 on a display. The content provider 156 may then review and/or modify their information.

Alternatively, or additionally, the presented GUI may present information pertaining to subscribing brand clients 154 who are also using the branded digital item system 100 to provide brands that may be suitable for use in the digital environment of the content provider 156. The content provider 156 can then identify one or more brand clients 154 of interest. The brand/content provider negotiator module 124 may then reach out to those particular brand clients 154 to initiate a transaction to use, and/or obtain rights to use, a brand to generate a branded digital item.

Once a brand client 154 has initiated contact with a content provider 156, or vice versa, the executing brand/content provider negotiator module 124 facilitates communication between the brand client 154 and the content provider 156 during a negotiation process. In a preferred embodiment, suitable GUIs are provided to both the brand client 154 and the content provider 156. The brand client 154 and the content provider 156, in an iterative and interactive manner, may then negotiate suitable terms for the use of a particular brand of the brand client 154. For example, but not limited to, the brand client 154 and the content provider 156 may negotiate to define characteristics of a digital item that is to be branded to create the branded digital item for use in the digital environment of the content provider 156.

Once a suitable arrangement between the brand client 154 and the content provider 156 has been negotiated, in an example embodiment, the branded digital item (DI) generator 126 is executed to generate a branded digital item. The generated branded digital item may then be stored into the digital item library 148. The branded digital item may be suitable for use only in a particular digital environment, or may be suitable for use in multiple digital environments.

As part of the negotiation process, the brand client 154 and the content provider 156 may reach an agreement to a predefined number of instances of the branded digital items that will be available for use by the digital environment. This limitation number may also be included as supplemental information in the digital item library 148, and/or may be included in another database or library. Further, other supplemental information memorializing the negotiated agreement may be saved in the digital item library 148, and/or may be included in another database or library.

Alternatively, or additionally, the branded digital item may be created by another entity, and then be communicated back to the branded digital item system 100. For example, the content provider 156 that understands the modeling requirements of their digital environment may generate the branded digital item based on the agreed upon brand and/or branded product. Alternatively, or additionally, the branded digital item may be retained by the content provider 156.

In some instances, the content provider 156 may support multiple digital environments that the branded digital item may be used in. If the agreement between the brand client 154 and the content provider 156 supports use of the branded digital item in multiple digital environments, information indicating those allowable multiple digital environments may be provided to the branded digital item system 100. Then, the user may use their purchased branded digital item in any one of the authorized multiple digital environments.

Alternatively, or additionally, another content provider 156 may support a digital environment that the branded digital item may be used in. If the agreement between the brand client 154 and the content provider 156 supports use of the branded digital item in the other digital environment, information indicating those other allowable digital environments may be provided to the branded digital item system 100. Then, the user may use their purchased branded digital item in any one of the authorized multiple digital environments.

After generation of the branded digital item and memorialization of pertinent information about the use of the branded digital item, the executing blockchain module 136 accesses the non-fungible token (and/or the information therein) to update the non-fungible token information. In other embodiments, the blockchain module 136 accesses the model data for the branded digital item and other supplemental information. The blockchain module 136 then generates an updated non-fungible token (or updated token information), or an updated branded digital item blockchain that includes an initial branded digital item block, depending upon the embodiment. The updated non-fungible token, the branded digital item, and/or the associated supplemental information is securely stored in the generated non-fungible token and/or the branded digital item blockchain.

The non-fungible token information and/or the branded digital item blockchain is securely encrypted with one or more blockchain keys that are used for encryption and decryption of the secure hash of the branded digital item blockchain in a non-fungible token-based embodiment. In other embodiments, the blockchain keys are used for encryption and decryption of the branded digital item blockchain. These secure blockchain keys are generated by the blockchain module 136. The generated branded digital item blockchain (with the updated non-fungible tokens or the branded digital item blocks) is stored into the branded digital item (DI) blockchain library 150. The associated blockchain keys are stored into the blockchain (BC) key library 152.

In a preferred embodiment, the blockchain keys are managed by the branded digital item system 100. The one or more blockchain keys are not provided to the brand client 154, the content provider 156, and/or the purchasing user.

An unexpected advantage provided by embodiments of the branded digital item system 100 is that integrity of a branded digital item can be reliably and effectively managed by the branded digital item system 100 since no outside party will have access to a blockchain key for implementing a change to a branded digital item blockchain. Legacy blockchain systems have the disadvantage that a party may lose, misplace, or forget their private blockchain key. If a private blockchain key is lost, the legacy blockchain may never be modified. In the context of branded digital items provided by embodiments of the branded digital item system 100, the possibility of a lost, misplaced or forgotten blockchain key will not occur since all blockchain keys are stored in the blockchain key library under control of the branded digital item system 100. Accordingly, the purchasing user is assured that in the event of a sale of their branded digital item to another party, that the branded digital item blockchain that secures their branded digital item can be modified to reflect the sale and the new purchasing user.

Another unexpected advantage of retaining blockchain keys within the branded digital item system 100 is that, in some embodiments, a single blockchain key may be used for encrypting and decrypting the branded digital item blockchain. Legacy blockchain systems typically use a public key and private key system to maintain secure integrity of a blockchain The process of encrypting and decrypting a legacy blockchain requires use of both public and private keys. Such encrypting and decrypting of legacy blockchains is extraordinarily complex. Here, the blockchain module 136 employing a single blockchain key may be significantly less complex and easier to manage as compared to legacy blockchain systems.

Further, blockchain hacking is an issue with any blockchain system. Another unexpected advantage provided by the branded digital item system 100 is that the branded digital item system 100, and the stored blockchain keys, are at significantly less risk to hacking. Since a branded digital item blockchain is never released to the public, or is not available to a peer-to-peer network, an unauthorized hacker must first hack into the branded digital item system 100. Security measures may be implemented to prevent such unauthorized access to the branded digital item system 100. Then, the unauthorized hacker must locate and access the particular branded digital item blockchain and associated blockchain key(s) of interest. Further layers of security measures may be implemented within the branded digital item system 100 to prevent unauthorized access to the stored branded digital item blockchain and the associated blockchain key(s).

The security and integrity of a branded digital item blockchain provided by embodiments of the branded digital item system 100 is particularly important to a user. The user must be confident that their purchased branded digital item is secure. Also, the user appreciates that they are not responsible for the safekeeping of the blockchain key(s), and that such blockchain key(s) are not accessible to unauthorized hackers. Otherwise, the user might be less inclined to buy, or pay a premium price for, a branded digital item.

In an example embodiment, when a request to use the branded digital item in a digital environment is received, the request includes information identifying the user. This information is compared with the user identity information stored in the branded digital item blockchain. If the user identity in the request matches the user identity information stored in the branded digital item blockchain, that user is an authorized user. Here, that user is authorized to use the branded digital item since that user has been verified as the purchaser or true owner of the branded digital item. That is, the 2D and/or 3D model data stored in the accessed branded digital item blockchain is communicated to the digital environment being used by the authorized user only if the identify information in the accessed branded digital item blockchain is the same as the information identifying the authorized user that is included in the request.

In practice, in a non-limiting example embodiment, the authorized user (via the client user 160) may begin an interaction with the branded digital item system 100 by communicating a request to the branded digital item system 100. In response to receiving the request from the user, the user interface module 128 is executed by the CPU 108. The user interface module 128 manages a variety of functions that a user may want to perform.

For example, but not limited to, the user may be interested in learning about available branded digital items that may be used in a particular digital environment of interest. This information may be stored in the digital item library 148. The client user 160 may upload information identifying available branded digital items and/or digital environments that may use a branded digital item. A suitable GUI may be generated by the user interface module 128 for presentation on a display of the client user 160.

The client user 160 may also upload various conditions under which the user would be willing to acquire the branded digital item on interest, such as a purchase price, game points, or the like. The brand client 154 might upload expected pricing information for use of their brand. The client user 160 might upload limitations that define use limits to their purchased branded digital item. For example, but not limited to, the branded digital item of interest may be useable on multiple digital environments. Any suitable information of interest may be uploaded and communicated to a client user 160 for presentation to the user.

When the user interface module 128 is executing, a GUI is communicated to the client user 160, via the network connection 114. The GUI may present the information pertaining to one or more available branded digital items. The user may then review the information and/or purchase a particular branded digital item of interest. The GUI may be presented on a display of the client user 160 and/or on a display of another electronic device being used by the user, such as the example smart phone 164. If a reward or incentive is associated with a particular branded digital item, information pertaining to the reward or incentive may be presented to the user for their consideration. Some embodiments of a branded digital item system 100 may include a payment processing module (not shown) that receives payment from the user.

Alternatively, or additionally, the client user 160 may access the digital environment 158 and/or the content provider 156 directly to learn about and/or purchase a branded digital item(s). The digital environment 158 and/or the content provider 156 may generate the GUI that is presented by the client user 160. The GUI may be presented on a display of the client user 160 and/or on a display of another electronic device being used by the user, such as the example smart phone 164. The information pertaining to available branded digital item(s) that can be used on a particular digital environment(s) may be accessed by the digital environment 158 and/or the content provider 156 so that the GUIs presented to the user can be generated. In such embodiments, a payment processing module (not shown) that receives payment from the user may be implemented at the content provider 156 and/or within the digital environment.

In the various embodiments, during game-play in a digital environment, the user may be presented a page, GUI, menu, or the like indicating available branded digital items that they might purchase. If the user purchases a particular branded digital item, information pertaining to the purchase and the user may be saved into the client user data 142.

Further, the purchasing information may be used to update the branded digital item blockchain. The blockchain module 136 generates an updated non-fungible token and/or a new secure branded digital item blockchain that secures the particular purchased branded digital item.

At times, the user may be interested in consuming information pertaining to their purchased branded digital items. In response to a request initiated by the user, the custodial wallet module 132 accesses information about those purchased digital items from the digital item library 148 and/or the client user data 142. The digital wallet contains information identifying branded digital items purchased by the requesting user. This information may be used to generate a digital wallet GUI that is presented by the client user 160. The digital wallet GUI may use any suitable format to present information about the purchased branded digital items. The GUI may be presented on a display of the client user 160, and/or on a display of an electronic device being used by the user, such as the example smart phone 164.

The request to view a user's digital wallet may be initiated by the user directly with the branded digital item system 100. Alternatively, or additionally, the user request may be initiated by the client user 160 via the content provider 156 and/or the digital environment. The digital wallet information may then be presented by the client user 160 in a suitable GUI by the branded digital item system 100, the content provider 156, and/or the digital environment.

An unexpected advantage provided by embodiments of the branded digital item system 100 is that the entirety of the user's purchased branded digital items can be maintained in a single data repository. For instance, the user may have purchased multiple branded digital items that may be used in different incompatible digital environments. By providing the digital wallet information directly to the client user 160, the user may consume information pertaining to all of their purchased branded digital items regardless of the particular digital environments that the user may use from time to time. In contrast, a legacy digital wallet system may be limited to a particular content provider 156 and/or to a particular digital environment.

Further, the brand/content provider negotiator module 124 may analyze a particular branded digital item to determine if that branded digital item might be used on a different digital environment (other than the particular digital environment that the brand client 154 and the content provider module 122 have negotiated). Here, the branded digital item system 100 may make recommendations to the user that one or more other digital environments may be configured to use the purchased branded digital item. If there is interest on the part of the user in using their purchased branded digital item in another unauthorized digital environment, the brand/content provider negotiator module 124 may initiate a negotiation process between the brand client 154, the original content provider 156, and the additional content provider 156 in control of the other digital environment of interest to see if an arrangement can be reached for the user to use their branded digital item on the unauthorized digital environment. It is appreciated that in some instances, an additional payment may be required from the user to use their branded digital item in the other digital environment. If the parties successfully arrive at an arrangement whereby the user may use their purchased branded digital item in the other digital environment, then the various data maintained by the branded digital item system 100 to reflect that new authorized use. For example, but not limited to, the associated branded digital item blockchain may be updated to generate an updated branded digital item blockchain that reflects the authorization of the user to use their purchased branded digital item in the other digital environment.

With some branded digital items, one or more rewards or incentives may be available to the user. Tracking of performance of a task or other predefined activity, interchangeably referred to herein as brand use information, and transmittal of the reward or incentive to the user, is managed by the user reward module 130 in an example embodiment. The performance tracking, and/or issuance of the reward or incentive, may be memorialized within the information of an updated non-fungible token and/or an updated branded digital item blockchain. For example, but not limited to, a reward may be issued when the user's branded digital item, such as a branded shirt, enters into the field of view of and is viewed by ten other users participating in the digital environment. As another example of an activity that may result in an award or incentive after completion of the activity, the user may be required to fish a coupon or other virtual object out of a lake while wearing the branded shirt. Another example may be requiring the user to defeat a boss champion in combat using a branded virtual sword. As yet another example of an activity, the user may be required to go over 200 miles per hour with the branded virtual car. Completion of the task or activity by the user causes the digital environment to generate a trigger that causes the transmittal of the incentive or reward to the user. One skilled in the arts appreciates that the number and variety or tasks or activities that may result in an award or incentive are limitless. All such tasks and activities are intended to be within the scope of this disclosure.

As each view is counted, the instance of the counted view observed by the digital environment and is then communicated to the branded digital item system 100. The branded digital item system 100 then generates an updated non-fungible token and/or an updated branded digital item blockchain that memorializes the task count. Detection of task completion may be accomplished through a “smart contract” in the blockchain. When the task is completed (here, ten views of the branded digital item), a reward or incentive is generated and is transmitted to the user. The reward or incentive may be generated and/or transmitted by embodiments of the branded digital item system 100.

Alternatively, the reward or incentive may be tracked, generated and/or transmitted by another system or entity, such as the digital environment and/or the content provider. The corresponding reward information may be communicated to the branded digital item system 100. The tracking of performance, generation of the reward or incentive, the reward or incentive particulars, and/or the identity of the receiving user may be then memorialized within the information of an updated non-fungible token and/or an updated branded digital item blockchain by the blockchain module 136 which generates the updated non-fungible token information and/or the updated branded digital item blockchain. The updated non-fungible token information and/or the updated branded digital item blockchain may then be stored into the branded digital item blockchain library 150.

In some instances, a particular branded digital item may be available for resale to a new purchasing user. The secondary market module 136 manages the resale of branded digital items. If a user is interested in acquiring a branded digital item on the secondary market, the secondary market module 136 may access information pertaining to available branded digital items from the digital item library 148 and/or the branded digital item blockchain library 150. If the user elects to purchase a branded digital item on the secondary market, the secondary market module 136 may consummate the transaction. For example, but not limited to, the secondary market module 136 may accept payment from the new user and remit payment to the previous owner. In some situations, the secondary market module 136 may generate a message to the current owner of the branded digital item that indicates the proposed or pending purchase of that branded digital item. Optionally, the current owner may have to authorize the transaction before ownership is transferred to the new owner.

When the user is using a particular digital environment, the branded digital item must be available to the user during their use of the digital environment. In some embodiments, a request for the branded digital item is received at the branded digital item system 100. In response to receiving the request, the blockchain access module 138 is initiated by the CPU 108. In an example non-limiting embodiment, the blockchain access module 138, after authenticity verification, accesses the non-fungible token (and/or the information therein) associated with the authorized user from the branded digital item blockchain library 150. In other embodiments, the branded digital item is accessed from the branded digital item blockchain library 150. The accessed non-fungible token information and/or information in the branded digital item blockchain may then be communicated from the branded digital item system 100 for use in the digital environment.

In some instances, the user request for a particular branded digital item may be communicated from the client user 160, or from another device being used by the user, such as the smart phone 164. Alternatively, the user request may be communicated from the executing digital environment or from the associated content provider 156.

The user request includes information identifies the user and information identifying the particular digital environment(s) and/or the content provider 156. The blockchain access module 138 compares the user identification information in the received user request with the authorized user information residing in the non-fungible token and/or the current branded digital item blockchain. If a match is made between the requesting user identity and the stored authorized user identity, the non-fungible token and/or the branded digital item may be accessed from the branded digital item blockchain and released for use in the digital environment.

Additionally, or alternatively, the particular digital environment(s) and/or the particular content provider 156 identified in the user request are compared with authorized digital environments and/or content providers 156 indicated in the current branded digital item blockchain. If a match is made between the identity of the digital environment and/or content provider 156 indicated in the user request and the stored authorized digital environment(s) and/or authorized content providers 156, the non-fungible token information and/or the branded digital item may be accessed from the branded digital item blockchain and released for use in the digital environment.

In some instances, the released non-fungible token and/or the branded digital item is communicated to the digital environment, which then links to and/or incorporates the branded digital item into the digital environment. In other instances, the released non-fungible token information and/or the branded digital item is communicated to content provider 156. The content provider 156 may then install the received branded digital item into the digital environment and/or permit use of the branded digital item in the digital environment.

In some embodiments, an optional application programming interface (API) 140 stores a plurality of different APIs to facilitate operation of the branded digital item system 100. An API is a set of programming code that enables data transmission between one software product (here, embodiments of the branded digital item system 100) and another software product, such as a digital environment, software of the content provider 156, and/or software used by another electronic device, such as the non-limiting example smart phone 164. APIs may also contain the terms of this data exchange such as, but not limited to, which particular parties may access or use the branded digital item system 100.

One skilled in the art appreciates that preferred embodiments of the branded digital item system 100 are not implemented using an open peer-to-peer system architecture. Rather, embodiments of the branded digital item system 100 are preferably implemented using a closed system architecture that limits access to the branded digital item system 100. However, embodiments of the branded digital item system 100 may be implemented on a peer-to-peer system.

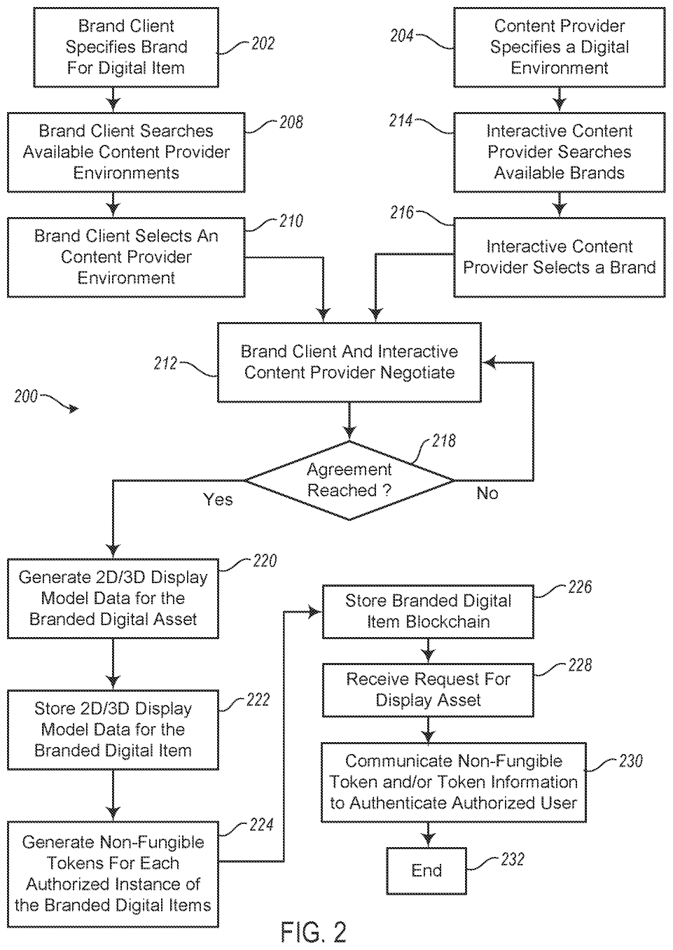

FIG. 2 is a flowchart 200 illustrating the operation of the branded digital item system 100 of FIG. 1. The flowchart 200 shows the architecture, functionality, and operation of a possible implementation of the software modules for implementing the branded digital item system 100. In this regard, each block may represent a module, segment, or portion of code, which comprises one or more executable instructions for implementing the specified logical function(s). It should also be noted that in some alternative implementations, the functions noted in the blocks may occur out of the order noted in FIG. 2, may include additional functions, and/or may omit some functions. For example, two blocks shown in succession in FIG. 2 may in fact be executed substantially concurrently, the blocks may sometimes be executed in the reverse order, or some of the blocks may not be executed in all instances, depending upon the functionality involved. All such modifications and variations are intended to be included herein within the scope of this disclosure.

The process of FIG. 2 may be initiated at block 202 or block 204. At block 204, a brand client 154 may specify a brand that is suitable for generating a branded digital item. At block 208, the brand client 154 searches for available content providers that they might be interested in having the brand used in that particular digital environment. At block 210 the brand client 154 selects a digital environment of interest.

The process then proceeds to block 212, wherein the process of negotiating an agreement between the brand client 154 and the content provider 156 that manages the digital environment of interest is initiated. Here, the brand/content provider negotiator module 124 initiates and facilitates the negotiations between the brand client 154 and the content provider 156.

Alternatively, the process may begin at block 204, when the content provider 156 specifies a digital environment that may be configurable to use a branded digital item. The content provider 156, at block 214, searches available brands that may be used to generate a branded digital item. When the content provider 156 identifies a brand of interest at block 216, the process proceeds to block 212 where a negotiation between the brand client 154 and the content provider 156 is initiated.

The process proceeds to block 218 to determine if an agreement between the brand client 154 and the content provider 156 has been reached. If no agreement has been reached (the NO condition), the process returns to block 212 for further negotiations.

If an agreement between the brand client 154 and the content provider 156 has been reached at block 218 (the YES condition), the process proceeds to block 220. At block 220, the 2D/3D model data for the branded digital item is generated. In some embodiments, the branded digital item is created by the content provider or by another entity. In other embodiments, the branded digital item may be generated by the branded digital item system 100.

At block 222, the generated 2D/3D model data for the branded digital item is stored into the digital environment. Alternatively, or additionally, the 2D/3D model data may be stored by the content provider. Alternatively, or additionally, the 2D/3D model data may be stored in the digital item library 148.

At block 224, in a preferred embodiment, the non-fungible tokens for each instance of the authorized number of branded digital items are generated. The non-fungible tokens (and/or the associated token information) are then stored into the ledger of a branded digital item blockchain, and a secure hash is generated to secure the ledger. (In other embodiments, an initial branded digital item blockchain with a first branded digital item block is generated. A single branded digital item blockchain is generated for each authorized instance of the branded digital item.)

At block 226, the generated branded digital item blockchain is stored into the branded digital item blockchain library 150.

At block 228, a request to use the branded digital item is received at the branded digital item system 100. Once authorization of the request has been verified, the non-fungible token, or information in the non-fungible token, is accessed from the branded digital item blockchain at block 230. The accessed non-fungible token and/or the token information is communicated to the digital environment and/or the content provider to verify authorized use of the branded digital item by the authorized user. (In other embodiments, the branded digital item may be communicated from the branded digital item system 100 and may be used in and/or may be inserted into the digital environment for use by the user at block 230.) The process then ends at block 232.

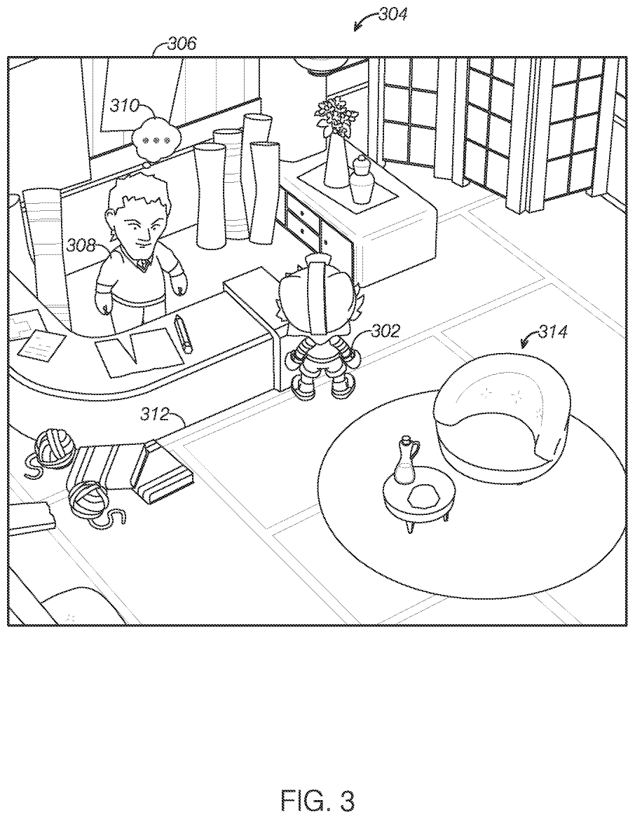

FIG. 3 is a conceptual diagram of a user's avatar 302 during gameplay of a hypothetical non-limiting virtual game. Here, a scene 304 is presented on a display 306 of the user's electronic device that the user is using for gameplay. The user appreciates that the avatar 302 represents the user during gameplay. One skilled in the arts appreciates that the number and variety or digital environments, and especially digital games, that may use a branded digital item are limitless. All such tasks and activities are intended to be within the scope of this disclosure

To facilitate disclosure of embodiments of the branded digital item system 100, the user's avatar 302 is conceptually illustrated as being located in a virtual store. One skilled in the art appreciates that the shopkeeper 308 and the user's avatar 302 are having a dialog, as represented by the dialog balloon 310 showing the text of the ongoing dialog. In some embodiments, the dialog may be alternatively or additionally presented to the user using audible speech.

The shopkeeper 308 is a graphical avatar that is generated and managed by the game of a content provider that provides the particular game to the user. The game itself may be downloaded and be executed on the electronic device of the user. Alternatively, the game may be executing remotely under the control of the content provider. In some instances, the shopkeeper 308 and/or other avatars (not shown) may be associated with other game players who are concurrently playing the game in an interactive manner with the user.

Various other graphical artifacts are presented in the scene 304 to facilitate gameplay. For example, the shopkeeper 308 is standing behind a counter 312 with various graphical objects distributed about the viewing area of the scene 304. For example, a rug, chair and table 314 are illustrated in the foreground of the scene 304.

At this juncture in the gameplay, the reader may assume in this simplified hypothetical conceptual example that the game software that is presenting the scene 304 has not yet established communications with the branded digital item system 100 (FIG. 1). That is, the particular user represented by the avatar 302 has not yet purchased any digital items that are available from a brand client.

At some point in gameplay, the user would indicate that they are interested in acquiring one or more branded digital items for use during their gameplay. The user may make this indication, or generate a user request, in any suitable manner during gameplay. In response to the user request, a communications link is established between the electronic device managing the game software and an embodiment of the branded digital item system 100, preferably through network 162 via the network connection 114 (FIG. 1). Other types of digital environments would permit the user to make requests for a branded digital item.

The user request, at this juncture, includes information that identifies the user and the particular game (digital environment) and/or the content provider. The user interface module 128, or another module, accesses the digital item library 148 to identify branded digital items that are compatible with the particular game or other digital environment being played by the user, and that branded digital items are available for purchase. Once a plurality of game compatible branded digital items have been identified, information corresponding to the available branded digital items are communicated to the electronic device that is managing gameplay or use of a particular digital environment. The information may include graphical information that is used to render an image of the available branded digital item to the user on display 306.

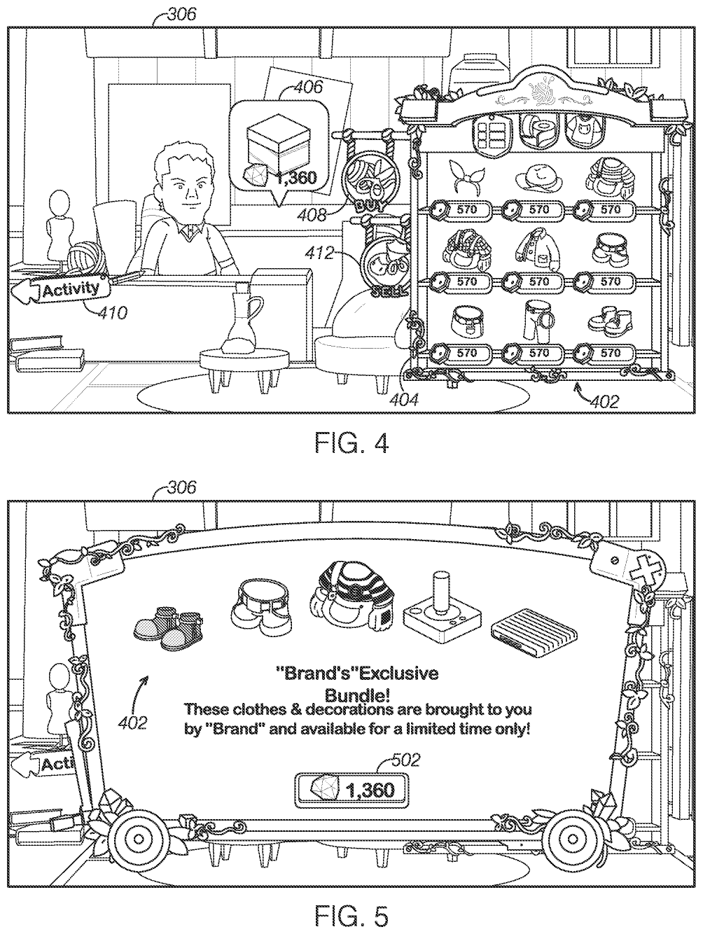

Depending upon how the content provider has constructed their game or other digital environment, the information pertaining to the compatible branded digital items is presented to the user. FIG. 4 is a conceptual presentation of branded digital items 402 that are available for purchase by the user. Here, the items are presented on a virtual shelf 404. An image represented the particular branded digital item 402 and an associated purchase price are shown to the user. The purchase price may be in real currency, in virtual currency, in game points, or the like.

To further illustrate operation of the branded digital item system 100, a group package icon 406 may be indicated to the user. The user appreciates that the group package icon 406 is associated with a bundled group of branded digital items 402 that are being offered to the user at a special incentive price (here, for 1,360 points). The shopkeeper 308 may textually and/or audibly describe the content of the package 406 to the game-playing user.

By viewing the various game compatible branded digital items 402, the user may elect to purchase one or more of the indicated branded digital items 402. In this simplified conceptual example, the user would select particular branded digital items 402 of interest, and then activate the “buy icon” 408 to initiate the purchase process. Alternatively, if the user is not interested in acquiring one or more of the branded digital items 402, the user may select the return to activity icon 410 to return to gameplay.

If the user has selected one of the branded digital items 402 for purchase, information memorializing the purchase is then communicated to the branded digital item system 100. The blockchain module 136 accesses the branded digital item blockchain associated with the branded digital item 402 from the branded digital item blockchain library 150. The blockchain module 136 then accesses the associated non-fungible token information (or, in other embodiments, decrypts the branded digital item blockchain) using the associated blockchain key(s) stored in the blockchain key library 152 (which only the branded digital item system 100 has access to). An updated non-fungible token (and/or updated token information) and/or an updated branded digital item blockchain is generated, and then is added to the branded digital item blockchain which memorializes the purchase of the branded digital item 402 by the purchasing user. The information added into the branded digital item blockchain includes information identifying the user, information identifying the game (and/or the digital environments) that the branded digital item may be used in, optional information identifying the content provider, and/or the 2D and/or 3D model data of the branded digital item. The blockchain module 136 then secures the branded digital item blockchain with a new hash or a newly generated branded digital item block, depending upon the embodiment. The blockchain module 136 then stores the secure branded digital item blockchain back into the branded digital item blockchain library 150. If multiple branded digital items 402 are to be purchased, the process is repeated for each of the branded digital items 402.

After purchase, the non-fungible token and/or the non-fungible token information, and/or the 2D and/or 3D model data of the branded digital item, and/or other supplemental information of interest may be optionally communicated from the branded digital item system 100 back to the digital environment and/or the content provider. Accordingly, the user may then use their purchased branded digital item 402 in the associated digital environment.

FIG. 5 is a conceptual presentation of a group of bundled and unbranded branded digital items that are available for purchase as a group by the user. Here, assuming that the user has selected the group package icon 406 (FIG. 4), additional information describing the available bundled group of branded digital items 402 associated with the package 406 is presented to the user. In response to the user selecting the purchase button 502, the game (digital environment) and/or the content provider communicate the purchase information of the group of branded digital items 402 to the branded digital item system 100. The branded digital item system 100 then accesses the associated branded digital item blockchains for each digital item, creates an updated non-fungible token (and/or updated token information) and/or an updated branded digital item blockchain memorializing the purchase, and then secures the updated branded digital item blockchain. The updated branded digital item blockchain is then saved into the branded digital item blockchain library 150. The non-fungible token and/or the non-fungible token information, and/or the 2D and/or 3D model data of the branded digital item, may be optionally communicated back to the digital environment and/or the content provider.

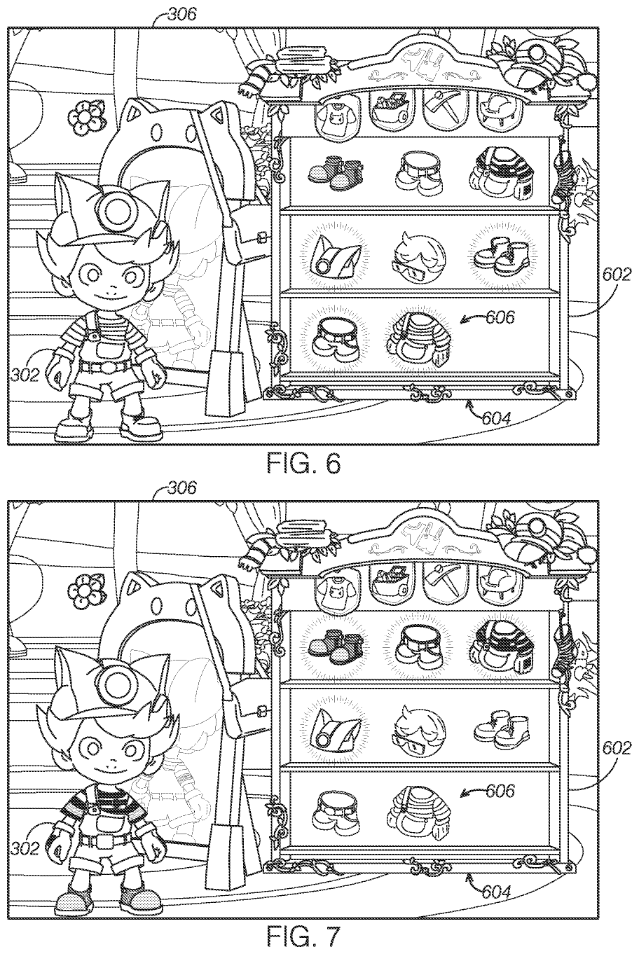

FIG. 6 is a conceptual presentation of a digital wallet 602 that shows purchased branded digital items that are available for use by the user. When the user is interested in reviewing their purchased branded and/or unbranded digital items, the user causes the digital environment, such as the game or other digital environment, to initiate a request to view branded digital items in their digital wallet. A request is sent to the branded digital item system 100 from the digital environment and/or the content provider. The request includes at least identity information of the user. Optionally, information about the particular digital environment and/or the content provider may be included in the request.

The executing custodial wallet module 132 accesses information from the branded digital item blockchain library 150 to identify blockchains associated with the authenticated requesting user. For example, information in the associated non-fungible token may be accessed to authenticate the user. Alternatively, or additionally, a relational database or the like may identify and authenticate users and their purchased branded digital items. Information corresponding to the branded digital items for the requesting user is then communicated from the branded digital item system 100 to the digital environment and/or the content provider. The information may include information to render an image of a digital item in the presented digital wallet 602.

To conceptually illustrate presentation of the owned branded digital items to a user, FIG. 6 presents a simplified hypothetical digital wallet 602 on the display 306, which resembles a shelf. In this hypothetical example, the avatar 302 of the user is concurrently presented adjacent to the digital wallet 602. The avatar 302 is “wearing” a plurality of different branded or unbranded digital items (skins), such as a hat, boots, a pair of pants, and a shirt top. These currently “worn” digital items are indicated in the digital wallet 602 using suitable highlighting, conceptually indicated using a circle of short lines in FIG. 6. Any suitable form of a digital wallet 602 and/or any suitable manner of highlighting digital items may be used depending upon choices made by the content provider. Here, images of recently purchased branded digital items that are not yet being “worn” by the user are shown in the user's digital wallet 602 (without highlighting). One skilled in the art appreciate that prior versions of a presented digital wallet 602 would not include branded digital items that the user had not yet purchased.

FIG. 7 is a conceptual presentation of the user “wearing” selected ones of the branded and unbranded digital items that the user has selected from their digital wallet. When compared to the avatar 302 illustrated in FIG. 6, it is apparent that the user has decided to change the appearance of their avatar 302 by selection of the branded digital items that includes the branded boots, the branded pants and the branded shirt top. As the user selects each of these branded digital items, the 2D and/or 3D model data of the branded digital item is used by the digital environment, here the game, to adjust the appearance of the user's avatar 302.

Returning to FIG. 4, the user might choose to sell one or more of their purchased branded digital items. For example, the hypothetical conceptual digital environment illustrates a sell icon 412. In response to selection of the sell icon 412 by the user, a request to sell one or more owned branded digital items is communicated to the branded digital item system 100. In response to receiving the sell request, the executing secondary market place module 134 accesses information from the branded digital item blockchain library 150 to identify non-fungible tokens and/or blockchains associated with the authenticated requesting user. Alternatively, or additionally, a relational database or the like may identify authorized users and their purchased branded digital items. However, true ownership information is always verified using a valid branded digital item blockchain.

Information corresponding to the branded digital items that are available for resale on a secondary market are then communicated from the branded digital item system 100 to the digital environment, the content provider, and/or the electronic device being used by the user (such as the non-limiting smart phone 164). The information may include information to render an image of a digital item in the presented digital wallet 602.

The user may then indicate owned branded digital items of interest that they wish to sell. Optionally, the user may specify a sale price, or a minimum sale price, that indicates the value that they would expect before a sale of their owned branded digital item is consummated with a new purchasing owner. Information identifying those branded digital items that the user is willing to sell is communicated back to the branded digital item system 100. The branded digital item system 100 then optionally updates the branded digital item blockchain to indicate the availability of the branded digital item for resale.

Other users may then search for available branded digital items that are available for purchase on the secondary market using the user interface module 128 to access the branded digital item system 100, and using the secondary marketplace module 134 to search for available branded digital items.

In some embodiments, the searching users may have previously indicated a preference for particular branded digital items. This preference information may be saved into the client user data 142. When a previously indicated branded digital item of interest becomes available on the secondary marketplace, a notification of the availability of the branded digital item may be communicated to that particular user.

Once the branded digital item is purchased, the branded digital item blockchain is updated with an updated non-fungible token information and/or an updated branded digital item blockchain. The updated branded digital item blockchain reflects the new ownership of the branded digital item. Then, only the new purchasing user may use that particular branded digital item.

The previous owner can no longer use that particular branded digital item once a branded digital item is sold and memorialized in the branded digital item blockchain. If the previous owner attempts to access the branded digital item, the most current branded digital item blockchain will indicate that they are no longer the true owner of the branded digital item, and access to the 2D and/or 3D model data of the branded digital item for that branded digital item is prevented.

It is appreciated by one skilled in the arts that there are infinite possible ways to use a digital item in a digital environment. Use of the branded digital item may be controlled by the executing digital environment and/or by the content provider. Similarly, one skilled in the arts appreciates that there are infinite ways in which digital wallet information may be indicated to the user. All such variations, now known or later developed, are intended to be included within the scope of this disclosure. The hypothetical examples disclosed herein are intended to be illustrative only to conceptually describe operation of embodiments of the branded digital item system 100 and are not intended to be limiting.

In some instances, the user may have purchased one or more branded digital items that can be used on a plurality of different digital environments. It is most likely that the plurality of digital environments were each developed by a different content provider. Some embodiments of the branded digital item system 100 may be configured to allow a user to review their digital wallet contents outside of any particular executing digital environment.

In such an embodiment, a user request is received at the branded digital item system 100 from the user. Authenticity of the user may be optionally verified by the user interface module 128 (FIG. 1). The executing user interface module 128 accesses information from the branded digital item blockchain library 150 to identify branded digital item blockchains and/or non-fungible tokens associated with the authenticated requesting user. Alternatively, or additionally, a relational database or the like may identify users and their purchased branded digital items. Information corresponding to the branded digital items for the requesting user is then communicated from the branded digital item system 100 to an electronic device being used by the user, such as the non-limiting smart phone 164. The information may include information to render an image of a digital item in the presented digital wallet 602. Alternatively, or additionally, the 2D and/or 3D model data of the owned branded digital item may be communicated to the user's electronic device.

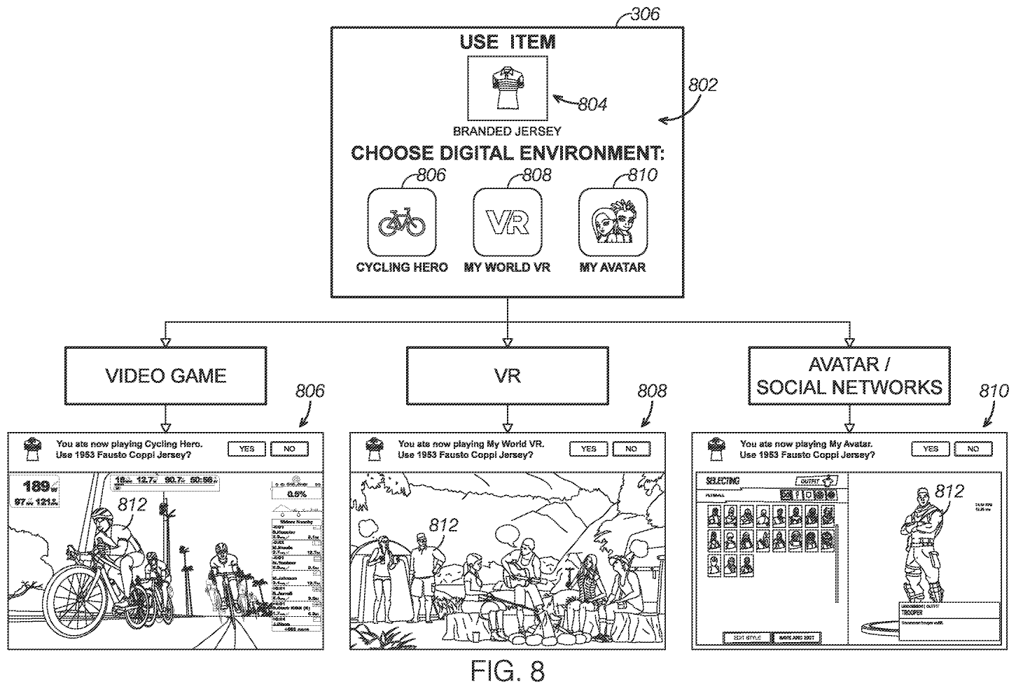

FIG. 8 conceptually illustrates a graphical user interface (GUI) 802 that permits a user to select a purchased branded digital item 808, a branded jersey, in a selected digital environment. One skilled in the art appreciates that the user has previously viewed the content of their digital wallet and has selected the branded jersey 804. In response to the user selection of a particular branded digital item of interest, in an example embodiment, the branded digital item system 100 accesses information in the branded digital item blockchain that identifies particular authorized digital environments in which the selected branded digital item may be used. It is appreciated that a brand client and a content provider have previously negotiated use of a particular branded digital item. In some instances, the content provider may have a plurality of different digital environments that the branded digital item may be used. Alternatively, or additionally, the brand client may have negotiated use of the same or like branded digital item with a different content provider who is managing one or more other digital environments.

In practice, it is the user who decides when and where their branded digital item will be used. The example GUI 802 presents an image of the branded digital item 804, and further conceptually indicates three different hypothetical digital environments that the branded digital item may be used in. The first non-limiting example digital environment 806 is a game pertaining to cycling, “Cycling Hero.” The second non-limiting example digital environment 808 is a virtual reality (VR) world, “My World VR.” The third non-limiting example digital environment 810 is an avatar/social network, “My Avatar.” Any number of digital environments in which the branded digital item may be used may be indicated on the GUI 802.

The GUI 802 allows the user to select a particular one of the digital environments 806, 808, 810 that their purchased branded digital item will be used in. In response to a selection, for example, of the Cycling Hero game, the non-fungible token stored in the branded digital item blockchain is accessed from the branded digital item blockchain library 150. Then, after user authentication based on the information in the non-fungible token is completed, the accessed 2D and/or 3D model data of the branded digital item is then used in the selected digital environment. Here, the avatar 812 representing the user in the cycling game will then be presented using the selected branded digital item.

In response to the selection, for example, of the My World VR environment, the 2D and/or 3D model data of the branded digital item used in the selected VR digital environment will be accessed and used in the digital environment. Here, the avatar 812 representing the user in the VR world will then be presented using the selected branded digital item. Similarly, in response to the selection, for example, of the My Avatar environment, the 2D and/or 3D model data of the branded digital item is used in the selected social network digital environment. Here, the avatar 812 representing the user in the social network world will then be presented using the selected branded digital item.

In some embodiments, an optional verification feature may be provided in a selected digital environment. Here, the user may be requested to confirm their choice to use their branded digital item in that particular digital environment.

Embodiments of the branded digital item system 100 may provide an industry wide technical standard and specification mandating the inclusion of all necessary information in the creation of a branded digital item or component of a branded digital item to make said good or component interoperable and compatible with other goods or component goods as well as with major VR, AR, social networking, and/or video gaming platforms and engines, referred to herein as digital environments. Such information including, but not being limited to, identifiers pointing to relevant hypermedia files, identifiers pointing to other digital goods coupled with relational tags describing relationships between the branded digital item and aforementioned other digital goods, present and historical good ownership, identifiers of entities participant in the creation of the branded digital item, a collection of programmatic modules associated with the branded digital item, and a list of identifiers pointing to programmatic modules associated with the branded digital item. Non-limiting examples of the items in the previous list, in respective order, include: a graphic file visually representing the branded digital item, a parent-child relationship between a pair of digital “pants” and a single digital “pocket” that can be worn on said pants, a list of the present and all past owners of a branded digital item, a list of unique identifiers associated with multiple brands that collaborated to design and produce a branded digital item effectively proving brand authenticity, a collection of software methods dictating a set of rules according to which the associated branded digital item can interact with its environment or alter its interaction behavior following certain events, a pointer to the hosted location of an artificial intelligence software that dictates behaviors or modifies features of the associated branded digital item.

Embodiments of the branded digital item system 100 enable a full stack web and mobile compatible application including but not limited to software modules for frontend client views, a database layer, and application business logic. The application of an example embodiment interfaces with the modules described herein, and possibly other modules, via a separate client application or API providing access to the network of computers composing the blockchain or distributed ledger technology system. Such embodiments support non programmatic (e.g. user friendly, point and click, touch-based) access to management of branded digital items under ownership by the user of the application where users and their owned branded digital items are identified according to one of two possible methods. In the first method, a non-custodial solution, users grant the branded digital item system 100 access to their blockchain network identity credentials stored securely in one of several places, including but not limited to their personal device, a cloud hosted machine, or in cold storage. In the second method, a custodial solution, users are not assumed to have already created identity credentials on the blockchain network. Here, users delegate to the branded digital item system 100 to create, if necessary, and manage users' identity in whichever manner seen most fit. In the latter case, it may be that the user has limited to no understanding or awareness of blockchain and distributed ledger technologies or the identity systems therein. However, relying on a custodial solution, said user is able to access and engage with the digital goods ecosystem described herein via the guise of a traditional account-base system created and managed by the content provider. In addition to providing users a platform for managing and viewing the branded digital items they own, the digital environment may provide additional features including integrations with major social networks including, but not limited to Facebook, Instagram, and Twitter. These integrations would enable the digital environment the ability to connect users with members of their social graph (colloquially referred to as “friends” or “followers”) that are also users of the digital environment and subsequently view their friends and followers collection of branded digital items, lend their branded digital items to their friends or followers, and receive lent branded digital items from their friends or followers.

Some embodiments may employ a software technology stack potentially composed of, but not limited to, a cloud hosted database, algorithmic graphical modeling tools, business logic layer, microservice APIs, and web and mobile compatible client application. This software stack functions as an engine and tool for packaging existing 2D and 3D models and related components—including, but not limited to, object meshes and skeletons—of branded digital items or creating 3D models, meshes, and skeletons of branded digital items in such a way to be compatible with a wide variety of VR, AR, and video game engines including, but not limited to, Unity and Unreal gaming engines. Translation service of this layer includes, but is not limited to, changing object features such as brightness, polygon count, saturation, and size. This tool may interface with the hypermedia storage solutions described herein in one of several ways. First, if a specific branded digital item already is paired with a 2D/3D model, set of meshes, and any other assets necessary to place the good in a VR, AR, or game context, all of which are stored, the embodiments described here may be used to produce additional 3D models, meshes, etc. that are compatible with additional engines or digital environments, which the original set of branded digital items were not compatible with. Second, if a specific branded digital item is not defined with a 2D/3D model, set of meshes, etc. embodiments may provide services and tools to be used by artists and designers to create branded digital items compatible with a variety of digital environments.

Embodiments may employ a set of software modules that may be composed of, but are not limited to, a cloud hosted database, business logic layers, microservice APIs, and web and mobile compatible client application. This collection of software modules together provide a suite of services to users, all of which revolve around the creation and management of a personal avatar which is unique to the user by, in part, use of their owned branded digital items. The embodiment further makes use of either third-party software or an internally developed software module that is able to size and generate a 3D model of the user's body by taking in a series of photos or videos either uploaded to the service or taken in real time on the user's mobile smartphone device within the application. The photos and videos, either uploaded or captured in real time, may be further used to construct a sophisticated model of the user's movement style and physical characteristics, including but not limited to, the user's gait. The generated 3D model can subsequently be customized in a variety of ways. As a non-limiting example, users can change or specify their eye color, hairstyle, and facial features, and/or refine their likeness to the digital avatar. In addition to serving as the basis for the generation of an avatar, the 3D model may be used in the context of such embodiments or another as a tool for the owner of the model, as a non-limiting example, to effectively try on physical clothing in a virtual context and make better sizing and fit choices, or stand by a certain vehicle to see how the user would pair and fit with that vehicle in real life. Making use of an API, embodiments may allow users to access their collection of branded digital items and have said branded digital items interact with their personal avatar. As a non-limiting example, a user could dress their avatar in a digital outfit composed of several individual branded digital item articles of clothing and footwear. Similarly, a user may enable their avatar to sit inside or by one of the digital automotive vehicles (an example branded digital item) they own. In this context, there are a variety of other social-oriented features that embodiments may provide to users. As a non-limiting example, users may share to social networks their clothed avatar and possibly include direct links to the location of the digital marketplace where the branded digital items their avatar is wearing were purchased. When the user shares their avatar wearing the virtual branded digital items, a software script allows the user to post a pre-filled post that does not require the user to write nor to add links. The social post comes with a pre-filled, standard text e.g. “Hey, look at me in my new ‘Name of Brand’ pants and ‘Name of Brand’ shoes, etc.”. The text may further state “Check them out here: Virtual [Brand] Pants: [link to the marketplace's page], Virtual [Brand] Shoes: [link to marketplace's page].”

Such sharing may occur via public APIs made available by social networking services, including but not limited to Facebook, Instagram, and Twitter or via a web browser plug-in that provides unique and custom avatar sharing services within the native interface of web platforms for the aforementioned social networking digital environments. Separately, allowing users to integrate their social networks into the branded digital item system 100 (by providing the application social network account login credentials) would enable the user to connect with members of their social graph (colloquially referred to as “friends” or “followers”) that are also users of the branded digital item system 100. Subsequently, users could view other avatars and collections, a non-limiting example would be avatars and virtual branded digital item collections of their friends and followers, as well as allow their own avatar to, for example, interact with, play with, compete with other avatars in a variety of contexts, such as the funniest looking avatar contest. Such avatar-to-avatar interactions could also be publicized via users' social network accounts. In addition to social networking services' APIs, embodiments may be enabled to integrate with external applications (e.g. BitMojis) or native features on user's smartphone devices via developer tools made available by device manufacturers and/or device operating system developers or via business agreements with aforementioned manufacturers and/or developers. As a non-limiting example of such native features, embodiments may be able to read a user's recent SMS or iMessage thread and using a 3rd party artificial intelligence engine, accessible via credentialed API, infer context from the messages and generate a sequence of actions the related avatars can take to, in a graphical context, “act out” the messaged exchange. Upon receiving this sequence of actions, the embodiment may illustrate the relevant avatars acting the messages out for the user in the form of a short video, and the user may be able to share this video via their social network channels, described previously.

Some embodiments may employ a set of software modules that may be composed of, but are not limited to, a cloud hosted database, business logic layers, microservice APIs, and web and mobile compatible client application. This application interfaces with the modules described herein, providing programmatic creation and issuance services of digital goods, and providing programmatic access to a user's digital wallet/closet/garage, and, in certain cases, an API service provided by sellers of physical and digital goods. Such an embodiment enables issuance and management of a digital identifiers linked to a physical product (e.g. a jersey), the initial authentication by the manufacturer, and the subsequent verification by the first owner, or subsequent owners, in order to verify the branded digital item authenticity and provide a chain of transactions of the branded digital items after being generated and sold.

The process for authenticating and verifying physical goods can happen in several ways, two of which are described here as non-limiting examples. In the first case, an embodiment may make use of 3^{rd} party software systems or internally developed separate software module employing computer vision technology to analyze the physical structure of an item and generate a unique identifier associated with that item. If generation and storage of such an identifier is a part of the manufacturing process for a physical good, the embodiment can run the same physical analyzing engine to generate an identifier and compare it against the stored values available via the seller's API services.

In the second case, a similar process is employed. However, rather than comparing identifiers produced by running the module described for analyzing physical goods, a shipped physical good may be tagged with an NFC chip with an embedded digital identifier that can be read by the embodiment and, subsequently, compared against a stored identifier value available via the manufacturer's API services.

To authenticate a physical product, the manufacturer would go through a set of steps, including taking one or more pictures of the product sold, which are analyzed by an algorithm and stored in a decentralized or centralized database, in order to authenticate the product. To verify a physical product that was previously authenticated by the manufacturer and that was designed to be paired with a digital “twin”, after a consumer has purchased it, the user will perform the required steps to, if necessary, transfer the digital twin (branded digital item) from the manufacturer to the owner, or from previous owner to new owner. When the product is purchased, and the user takes receipt of the physical product, the application will allow the user to know the product is authentic by taking a series of steps, including but not limited to taking a picture of the product. Once the product has been verified by a user, the application transfers ownership of the identifier from the manufacturer to the user, similarly as a non-limiting example to a title transfer of a vehicle, a house, or a limited edition item. The same process would occur when the first owner would sell the product to a second owner in a secondary market sale. Each identifier is linked to a 3D realistic object rendering (branded digital item) of the actual product, that will allow the user to dress their avatars, share the avatar and the product on social networks, and bring their digital twins inside other digital environments, such as and not limited to, video games, VR and AR environments.

It should be emphasized that the above-described embodiments of the branded digital item system 100 are merely possible examples of implementations of the invention. Many variations and modifications may be made to the above-described embodiments. All such modifications and variations are intended to be included herein within the scope of this disclosure and protected by the following claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

Therefore, having thus described the invention, at least the following is claimed:

1. A method that manages digital items, comprising:
generating a branded digital item in response to an agreement between a brand client and a content provider to use the branded digital item that is associated with a branded product in a digital environment of the content provider,
wherein the branded digital item is a graphical object that is readily recognizable to a user of the digital environment based on the branding information that is shown on the branded digital item, and
wherein the branded digital item comprises at least one of 2D and 3D model data that is used to render the branded digital item on a display of an electronic device being used by an authorized user during use of the digital environment by the authorized user;
generating a branded digital item blockchain after generating the branded digital item, wherein the branded digital item blockchain secures information memorializing the branded digital item;
storing the branded digital item blockchain in a digital item blockchain library;
receiving information corresponding to a purchase of the branded digital item by the authorized user;
accessing the branded digital item blockchain from the digital item blockchain library;
updating the branded digital item blockchain to memorialize purchase of the branded digital item by the authorized user, wherein the updated branded digital item blockchain includes a new information that includes identity information that identifies the authorized user; and
storing the updated branded digital item blockchain into the digital item blockchain library.

2. The method of claim 1, wherein the branded digital item blockchain includes information identifying the digital environment that uses the at least one of 2D and 3D model data during use of the digital environment by the authorized user.

3. The method of claim 1, wherein the agreement between the brand client and the content provider defines a number of the branded digital items that will be available for purchase, and wherein generating the branded digital item blockchain further comprises:
generating a number of non-fungible tokens, wherein each non-fungible token uniquely corresponds to one of the number of branded digital items that are available for purchase; and
storing each of the non-fungible tokens into a ledger of the digital item blockchain library,
wherein each non-fungible token includes information that identifies its unique corresponding branded digital item.

4. The method of claim 3, wherein updating the branded digital item blockchain to memorialize purchase of the branded digital item by the authorized user further comprises:
updating the non-fungible token information to memorialize purchase of the branded digital item by the authorized user, wherein the updated non-fungible token information includes a new information that includes identity information that identifies the authorized user.

5. The method of claim 4, wherein the purchase of the branded digital item by the authorized user is a first purchase of the branded digital item by a first authorized user, the method further comprising:
receiving information corresponding to a second purchase of the branded digital item by a second authorized user;
accessing a second branded digital item blockchain from the digital item blockchain library;
updating the non-fungible token information of a second non-fungible token to memorialize purchase of the branded digital item by the second authorized user, wherein the updated non-fungible token information of the second non-fungible token includes identity information that identifies the second authorized user, and
storing the updated non-fungible token information into the ledger of the digital item blockchain library.

6. The method of claim 1, further comprising:
receiving a request from at least one of an electronic device being used by the authorized user that owns the digital asset, a digital environment being used by the authorized user, and a content provider of the digital environment;
accessing the stored branded digital item blockchain associated with the branded digital item from the digital item blockchain library in response to receiving the request;
communicating the information that includes identity information that identifies the authorized user to at least one of the electronic device being used by the authorized user that owns the digital asset, to the digital environment being used by the authorized user, and the content provider,
wherein the branded digital item is presented to the authorized user during use of the digital environment by the authorized user.

7. The method of claim 6, wherein the request includes information identifying the authorized user, the method further comprising:
accessing identity information from the accessed branded digital item blockchain that identifies a purchaser of the branded digital item;
comparing the identify information in the accessed branded digital item blockchain with the information identifying the authorized user that is included in the request; and
communicating authorization to use the accessed branded digital item blockchain to the digital environment being used by the authorized user only if the identify information in the accessed branded digital item blockchain is the same as the information identifying the authorized user that is included in the request.

8. The method of claim 6, wherein digital environment is being concurrently used by a second user, and wherein the branded digital item is presented to the second user on a display of a second electronic device being used by the second user during their concurrent use of the digital environment.

9. The method of claim 1, further comprising:
receiving a request from an electronic device of the authorized user for information identifying a plurality of branded digital items that have been purchased by the requesting authorized user;
accessing each of the branded digital item blockchains that are associated with the authorized user from the digital item blockchain library;
obtaining branded digital item information from each of the accessed branded digital item blockchains that are associated with the authorized user, wherein the accessed information identifies the branded digital item stored in that accessed branded digital item blockchain;
generating a digital wallet graphical user interface (GUI) using the accessed branded digital item information; and
communicating the digital wallet GUI to the electronic device of the authorized user,
wherein the digital wallet GUI indicating the user's plurality of purchased branded digital items is presented on a display of the electronic device of the authorized user.

10. The method of claim 1, further comprising:
receiving a request to sell the branded digital item from an electronic device of the authorized user;
accessing the branded digital item blockchain from the digital item blockchain library;
updating the branded digital item blockchain to memorialize the request to sell the branded digital item; and
storing the updated branded digital item blockchain into the digital item blockchain library.

11. The method of claim 10, wherein the authorized user is an authorized first user, the method further comprising:
receiving purchase information pertaining to a purchase of the branded digital item by an authorized second user;
accessing the branded digital item blockchain from the digital item blockchain library;
updating the branded digital item blockchain to memorialize the purchase of the branded digital item by the authorized second user,
wherein the updated branded digital item blockchain includes information identifying the authorized second user,
wherein only the authorized second user may use the branded digital item after the purchase of the branded digital item; and
storing the updated branded digital item blockchain into the digital item blockchain library.

12. The method of claim 1, wherein prior to generating the branded digital item in response to the agreement between the brand client and the content provider, the method further comprising:
receiving brand information from the brand client pertaining to a brand product, wherein the brand information comprises at least descriptive information describing the brand and at least one image of the brand;
receiving digital environment information from the content provider pertaining to the digital environment that interacts with the authorized user, wherein the digital environment content information comprises at least descriptive information describing the digital environment;
providing the brand information and an identity of the brand client to the content provider; and
providing the digital environment information and an identify of the content provider to the brand client,
wherein after the agreement between the brand client and the content provider is reached, the branded digital item is generated.

13. The method of claim 1, further comprising:
receiving brand use information generated by at least one of the digital environment and the content provider, wherein the brand use information corresponds to completion of one of a task or activity during use of the interactive content program by the authorized user; and
updating the branded digital item blockchain to memorialize the brand use information.

14. The method of claim 13, further comprising:
receiving information pertaining to a reward that was given to the authorized user in response to completion of the task or activity;
accessing the branded digital item blockchain from the digital item blockchain library;
updating the branded digital item blockchain to memorialize the reward to the authorized user, wherein the updated branded digital item blockchain includes the information pertaining to the reward; and
storing the updated branded digital item blockchain into the digital item blockchain library.

15. A branded digital item system that manages digital items, comprising:
a central processing unit (CPU);
a network connection communicatively coupling the CPU to a network;
a memory communicatively coupled to the CPU, the memory comprising a plurality of memory storage regions;
a brand client module residing in a first one of the plurality of memory storage regions,
wherein the brand client module receives brand information from a brand client pertaining to a brand, and
wherein the brand information comprises at least descriptive information describing the brand and at least one image of the brand;
a content provider module residing in a second one of the plurality of memory storage regions,
wherein the content provider module receives digital environment information from a content provider pertaining to a digital environment that interacts with an authorized user, and
wherein the digital environment content information comprises at least descriptive information describing the digital environment;
a brand and content provider negotiator module stored in a third one of the plurality of memory storage regions,
wherein the brand and content provider negotiator module receives a brand offer pertaining to the brand from the brand client,
wherein the brand and content provider negotiator module receives a digital environment offer pertaining to the digital environment from the interactive content provider,
wherein the brand and content provider negotiator module facilitates a negotiation between the brand client and the interactive content provider so that the digital environment offer is acceptable to the brand client, and so that the brand offer is acceptable to the interactive content provider; and
a branded digital item generator stored in a fourth one of the plurality of memory storage regions,
wherein the branded digital item generator generates a branded digital item corresponding to the brand in response to the brand client acceptance of the digital environment offer and in response to the interactive content provider acceptance of the brand offer,
wherein the branded digital item comprises at least one of 2D and 3D model data of the branded digital item,
wherein the branded digital item is compatible with the digital environment, and
wherein an image of the branded digital item is presented to the user during use of the digital environment by the authorized user.

16. The branded digital item system of claim 15, further comprising:
a blockchain module stored in a fifth one of the plurality of memory storage regions,
wherein the blockchain module generates a branded digital item blockchain based on the generated branded digital item, and
wherein an initial branded digital item block of the branded digital item blockchain has information authorizing use of the 2D and 3D model data of the branded digital item by the authorized user in the digital environment; and
a digital item blockchain library stored in a sixth one of the plurality of storage regions that stores the generated branded digital item blockchain associated with the branded digital item with a plurality of other branded digital item blockchains associated with different branded digital items.

17. The branded digital item system of claim 16, further comprising:
a blockchain access module stored in a seventh one of the plurality of memory storage regions,
wherein the blockchain access module accesses the stored branded digital item blockchain associated with the branded digital item in response to request from at least one of the authorized user that owns the digital asset, a digital environment being used by the authorized user, and a content provider of the digital environment,
wherein the blockchain access module accesses information of a non-fungible token associated with the branded digital item from the accessed branded digital item blockchain, and
wherein the information of the non-fungible token is communicated to an electronic device that is operating the digital environment so that the image of the branded digital item is presented to the authorized user during use of the digital environment by the authorized user.

18. The branded digital item system of claim 17, wherein the authorized user is a first user, and further comprising:
a secondary marketplace module stored in an eighth one of the plurality of memory storage regions,
wherein the marketplace module presents information indicating availability of the branded digital item to a second user,
wherein the marketplace module changes ownership of the branded digital item from the first user to the second user in response to the second user purchasing the branded digital item,
wherein the blockchain access module generates an updated information for the non-fungible token that is returned to a ledger of the branded digital item blockchain associated with the branded digital item, and
wherein the updated non-fungible token information includes information identifying the second user as the new owner of the branded digital item.

19. The branded digital item system of claim 18, wherein:
wherein the blockchain access module accesses the stored branded digital item blockchain associated with the branded digital item in response to at least one of a user request from the second user that owns the digital asset, from a digital environment being used by the second user, and from a content provider of the digital environment,
wherein the blockchain access module accesses the information of the non-fungible token in the branded digital item block, and
wherein the information of the non-fungible token is communicated to an electronic device that is operating the digital environment so that the image of the branded digital item is presented to the second user during use of the digital environment by the second user.

20. The branded digital item system of claim 15, further comprising:
a user reward module stored in a fifth one of the plurality of memory storage regions,
wherein the user reward module receives information pertaining to one of a reward or an incentive generated by the digital environment that has been received by the authorized user, and
wherein the information pertaining to one of a reward or incentive is used to update the information in the associated branded digital item blockchain.
